(19) United States
(12) Patent Application Publication
(10) Pub. No.: US 2019/0317425 A1
(43) Pub. Date: Oct. 17, 2019

(54) TRANSFER DEVICE AND IMAGE FORMING APPARATUS WITH ADHERENT REMOVAL FUNCTION

(71) Applicant: FUJI XEROX CO., LTD., Tokyo (JP)

(72) Inventor: Akira SHIMODAIRA, Kanagawa (JP)

(73) Assignee: FUJI XEROX CO., LTD., Tokyo (JP)

(21) Appl. No.: 16/118,456

(22) Filed: Aug. 31, 2018

(30) Foreign Application Priority Data
Apr. 12, 2018 (JP) 2018-076756

(51) Int. Cl. G03G 15/08; G03G 15/06

(52) U.S. Cl. CPC G03G 15/0815; G03G 15/1615; G03G 15/065

(57) ABSTRACT

A transfer device includes a transfer member that rotates to transfer an image held on an image carrier to a medium; an opposing member opposing the transfer member and forming, between the opposing member and the transfer member, a transfer area for an image to be transferred; a recovery member disposed in contact with the transfer member to electrically attract and recover an adherent adhering to the transfer member; and a bias-voltage applicating device that applies a transfer bias voltage to the transfer area via the recovery member, the transfer member, and the opposing member.

### CROSS-REFERENCE TO RELATED APPLICATIONS

This application is based on and claims priority under 35 USC 119 from Japanese Patent Application No. 2018-076756 filed Apr. 12, 2018.

### BACKGROUND

### Technical Field

The present invention relates to a transfer device and an image forming apparatus.

### Summary

A transfer device according to an aspect of the invention includes a transfer member that rotates to transfer an image held on an image carrier to a medium; an opposing member opposing the transfer member and forming, between the opposing member and the transfer member, a transfer area for an image to be transferred; a recovery member disposed in contact with the transfer member to electrically attract and recover an adherent adhering to the transfer member; and a bias-voltage applicating device that applies a transfer bias voltage to the transfer area via the recovery member, the transfer member, and the opposing member.

### BRIEF DESCRIPTION OF THE DRAWINGS

Exemplary embodiments of the present invention will be described in detail based on the following figures, wherein:

FIG. 1 is an overall view of an image forming apparatus according to a first exemplary embodiment;

FIG. 2 illustrates a related portion of an image recording portion according to the first exemplary embodiment; and

FIG. 3 illustrates a related portion of a transfer device according to an example.

### DETAILED DESCRIPTION

Referring now to the drawings, specific exemplary embodiments of the invention (hereinafter referred to as exemplary embodiments) are described. The invention, however, is not limited to the exemplary embodiments described below.

For ease of understanding of the following description, throughout the drawings, the frontward and rearward directions are expressed as an X-axis direction, the leftward and rightward directions are expressed as a Y-axis direction, and the upward and downward directions are expressed as a Z-axis direction. Directions or sides denoted by arrows X, -X, Y, -Y, and -Z respectively indicate the frontward, rearward, rightward, leftward, upward, and downward directions or the front side, the rear side, the right side, the left side, the upper side, and the lower side.

In each of the drawings, an encircled dot denotes an arrow directing from the far side to the near side of the drawing and an encircled cross denotes an arrow directing from the near side to the far side of the drawing.

In the following description using the drawings, components other than those necessary for the description are appropriately omitted for ease of understanding.

### First Exemplary Embodiment

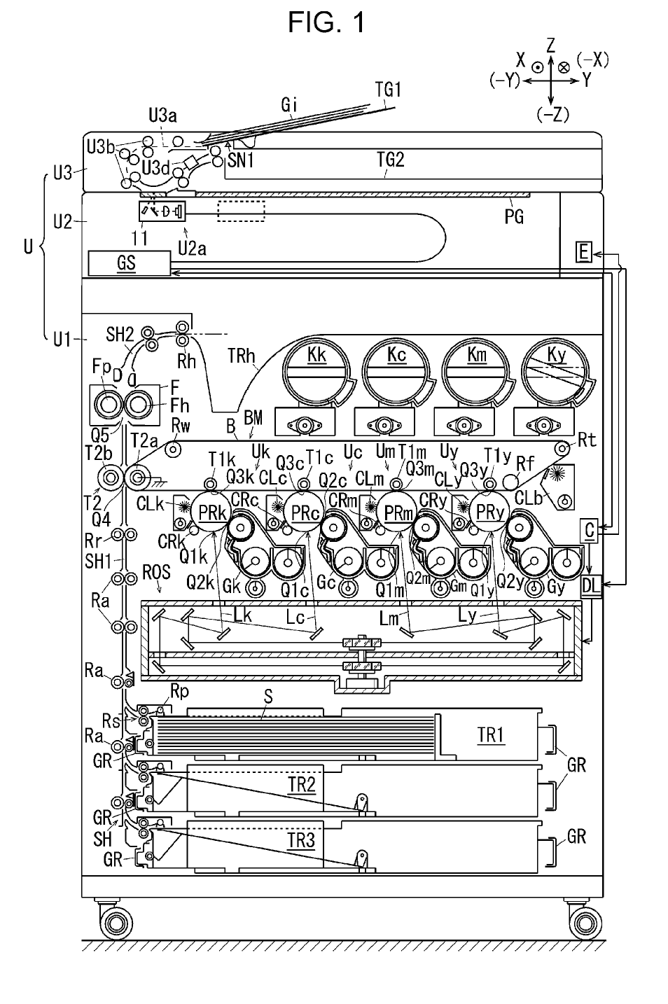

FIG. 1 is an overall view of an image forming apparatus according to a first exemplary embodiment.

In FIG. 1, a copying machine U, serving as an example of an image forming apparatus according to a first exemplary embodiment of the invention, is an example of a recording unit and includes a printer unit U1, a scanner unit U2, and an auto-feeder U3. The printer unit U1 is an example of an image recording apparatus. The scanner unit U2 is an example of a reading portion, serves an example of an image reading device, and is supported on the printer unit U1. The auto-feeder U3 is an example of an original-document transporting device, and is supported on the scanner unit U2.

An original-document tray TG1, which is an example of a medium container, is disposed on the auto-feeder U3. The original-document tray TG1 is capable of holding a stack of multiple original documents Gi that are to be copied. An original-document output tray TG2, which is an example of an original-document ejection portion, is disposed below the original-document tray TG1. Original-document transport rollers U3b are disposed along an original-document transport path U3a between the original-document tray TG1 and the original-document output tray TG2.

A platen glass PG, which is an example of a transparent original-document table, is disposed on the upper surface of the scanner unit U2. In the scanner unit U2 according to the first exemplary embodiment, a reading unit U2a, which is an example of a reading portion, is disposed below the platen glass PG. The reading unit U2a according to the first exemplary embodiment is supported along the undersurface of the platen glass PG so as to be movable in the leftward and rightward directions, which are examples of a sub-scanning direction. Normally, the reading unit U2a is stationary at an initial position expressed by a solid line in FIG. 1. The reading unit U2a is electrically connected to an image processor GS.

In the auto-feeder U3 according to the first exemplary embodiment, a reading sensor U3d, which is an example of a second reading member, is disposed on the original-document transport path U3a at a position downstream, in the direction in which an original document is transported, of a portion that the reading unit U2a faces. The reading sensor U3d is capable of reading a surface of an original document Gi opposite to the surface of the original document Gi read by the reading unit U2a.

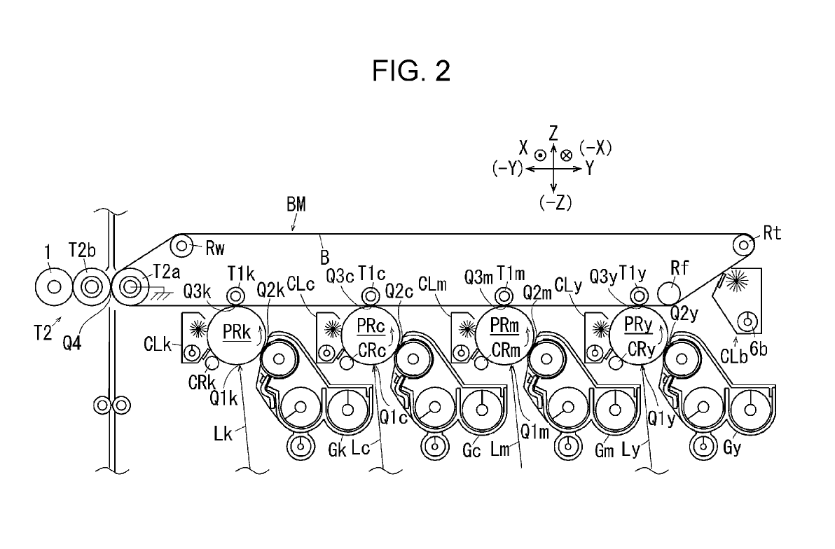

FIG. 2 illustrates a characteristic portion of an image recording unit according to the first exemplary embodiment.

The image processor GS is electrically connected to a write circuit DL of the printer unit U1. The write circuit DL is electrically connected to an exposure device ROS, which is an example of a latent-image forming device.

The exposure device ROS according to the first exemplary embodiment is capable of emitting laser beams Ly, Lm, Lc, and Lk respectively corresponding to yellow (Y), magenta (M), cyan (C), and black (K) colors and serving as examples of write light beams. The exposure device ROS is capable of emitting laser beams Ly to Lk corresponding to signals input from the write circuit DL.

In FIG. 1, photoconductors PRy, PRm, PRc, and PRk, which are examples of image carriers, are disposed above the exposure device ROS. In FIG. 1 and FIG. 2, the areas of the photoconductors PRy to PRk irradiated with the corresponding laser beams Ly to Lk respectively constitute write areas Q1y, Q1m, Q1c, and Q1k.

Charging rollers CRy, CRm, CRc, and CRk, which are examples of charging devices, are disposed upstream of the corresponding write areas Qly to Qlk in the direction in which the photoconductors PRy, PRm, PRc, and PRk rotate. The charging rollers CRy to CRk according to the first exemplary embodiment are supported so as to be driven to rotate in contact with the respective photoconductors PRy to PRk.

Developing devices Gy, Gm, Gc, and Gk, which are examples of developing devices, are disposed downstream of the corresponding write areas Q1y to Q1k in the direction in which the photoconductors PRy to PRk rotate. The areas over which the photoconductors PRy to PRk face the corresponding developing devices Gy to Gk respectively constitute development areas Q2y, Q2m, Q2c, and Q2k.

First transfer rollers T1y, T1m, T1c, and T1k, which are examples of first transfer members, are disposed downstream of the corresponding developing devices Gy to Gk in the direction in which the photoconductors PRy to PRk rotate. The areas over which the photoconductors PRy to PRk face the corresponding first transfer rollers T1y to T1k respectively constitute first transfer areas Q3y, Q3m, Q3c, and Q3k.

Photoconductor cleaners CLy, CLm, CLc, and CLk, which are examples of first transfer cleaners, are disposed downstream of the corresponding first transfer rollers T1y to T1k in the direction in which the photoconductors PRy to PRk rotate.

The Y-color photoconductor PRy, the charging roller CRy, the exposure device ROS that emits a laser beam Ly of the Y color, the developing device Gy, the first transfer roller T1y, and a photoconductor cleaner CLy constitute a Y-color image forming unit Uy, which is an example of a Y-color visible image forming device according to the first exemplary embodiment that forms a toner image. Similarly, each of the photoconductors PRm, PRc, and PRk, the corresponding one of the charging rollers CRm, CRc, and CRk, the exposure device ROS, the corresponding one of the developing devices Gm, Gc, and Gk, the corresponding one of the first transfer rollers T1m, T1c, and T1k, and the corresponding one of the photoconductor cleaners CLm, CLc, and CLk constitute a M-color, C-color, or K-color image forming unit Um, Uc, or Uk.

A belt module BM, which is an example of an intermediate transfer device, is disposed above the photoconductors PRy to PRk. The belt module BM includes an intermediate transfer belt B, which is an example of an image carrier and an example of an intermediate transfer member. The intermediate transfer belt B is constituted of an endless member.

The intermediate transfer belt B according to the first exemplary embodiment is rotatably supported by a tension roller Rt, which is an example of a tensioning member, a walking roller Rw, which is an example of a member that compensates for deviation, an idler roller Rf, which is an example of a driven member, a backup roller T2a, which is an example of an opposing member facing a second transfer area, and the first transfer rollers T1y, T1m, T1c, and T1k. In the first exemplary embodiment, the intermediate transfer belt B rotates when driving power is transmitted to a backup roller T2a, which is an example of a driving member.

A second transfer roller T2b, which is an example of a second transfer member, is disposed at such a position as to face the backup roller T2a with the intermediate transfer belt B interposed therebetween. Components including the backup roller T2a and the second transfer roller T2b constitute a second transfer device T2 according to the first exemplary embodiment, which is an example of a transfer device. The area over which the second transfer roller T2b comes into contact with the intermediate transfer belt B constitutes a second transfer area Q4.

A belt cleaner CLb, which is an example of a cleaner that cleans the intermediate transfer body, is disposed downstream of the second transfer area Q4 in the direction in which the intermediate transfer belt B rotates.

Components including the first transfer rollers T1y to T1k, the intermediate transfer belt B, and the second transfer device T2 constitute a transfer device according to the first exemplary embodiment, which is an example of a transfer member. The image forming units Uy to Uk and the transfer device constitute an image recording unit according to the first exemplary embodiment.

In FIG. 1, three pairs of right and left guide rails GR, which are examples of guide members, are disposed at three different levels below the image forming units Uy to Uk. Each pair of guide rails GR support one of paper feed trays TR1 to TR3, which are examples of medium containers, in such a manner as to allow the paper feed tray to be inserted and removed frontward and rearward. The paper feed trays TR1 to TR3 hold recording sheets S, which are examples of media.

A pickup roller Rp, which is an example of a pickup member, is disposed at the upper left of each of the paper feed trays TR1 to TR3. Separation rollers Rs, which are examples of separation members, are disposed downstream of the pickup rollers Rp in the direction in which a recording sheet S is transported. A paper feed path SH1, which extends upward and which is an example of a medium transport path, is formed downstream of the separation rollers Rs in the direction in which a recording sheet S is transported. Multiple transport rollers Ra, which are examples of transport members, are disposed on the paper feed path SH1.

Registration rollers Rr, which are examples of members that adjust timing of sheet transport, are disposed on the paper feed path SH1 at positions upstream of the second transfer area Q4.

A fixing device F, which is an example of a fixing member, is disposed downstream of the second transfer area Q4 in the direction in which a recording sheet S is transported. The fixing device F includes a heating roller Fh, which is an example of a member for fixing an image by heating, and a pressing roller Fp, which is an example of a member for fixing an image by pressing. The area over which the heating roller Fh and the pressing roller Fp come into contact with each other constitutes a fixing area Q5.

A paper ejection path SH2, which is an example of a transport path, is disposed above the fixing device F. A paper output tray TRh, which is an example of a medium output portion, is formed on the upper surface of the printer unit U1. The paper ejection path SH2 extends toward the paper output tray TRh. Ejection rollers Rh, which are examples of medium transport members, are disposed at a downstream end portion of the paper ejection path SH2.

### Description of Image Forming Operation

When the copying machine U according to the first exemplary embodiment having the above-described configuration copies an original document Gi manually placed on the platen glass PG by an operator, the reading unit U2a moves leftward and rightward from the initial position to scan the original document Gi on the platen glass PG while the reading unit U2a irradiates the original document Gi with light. When the copying machine U copies an original document Gi while automatically transporting the original document Gi using the auto-feeder U3, the reading unit U2a moves from the initial position to an original-document reading position, drawn with the broken line in FIG. 1, and stops at the original-document reading position. Multiple original documents Gi contained in the original-document tray TG1 are sequentially transported to the original-document reading position on the platen glass PG, pass through the original-document reading position, and are then ejected to the original-document output tray TG2. Thus, the original documents Gi that sequentially pass through the reading position on the platen glass PG are exposed to light and scanned by the reading unit U2a that remains stationary. The light reflected off the original documents Gi is received by the reading unit U2a. The reading unit U2a converts the received light that has been reflected off the original documents Gi into electric signals. In the case where both sides of an original document Gi are to be read, the reading sensor U3d also reads the original document Gi.

Electric signals output from the reading unit U2a are input to the image processor GS. The image processor GS converts electric signals of an image having red, green, and blue (RGB) colors read by the reading unit U2a into image data of yellow (Y), magenta (M), cyan (C), and black (K) for forming latent images. The image processor GS outputs the image data obtained after the conversion to the write circuit DL of the printer unit U1. In the case where the image is a single-color image or a monochromatic image, the image processor GS outputs image data of only black (K) to the write circuit DL.

The write circuit DL outputs control signals corresponding to the input image data to the exposure device ROS. The exposure device ROS outputs laser beams Ly to Lk corresponding to the control signals.

When an image forming operation is started, the photoconductors PRy to PRk start rotating. The power circuit E applies charging voltages to the charging rollers CRy to CRk. Thus, the surfaces of the photoconductors PRy to PRk are electrically charged by the charging rollers CRy to CRk. In the write areas Q1y to Q1k, electrostatic latent images are formed by the laser beams Ly to Lk on the surfaces of the electrically charged photoconductors PRy to PRk. In the development areas Q2y to Q2k, the electrostatic latent images on the photoconductors PRy to PRk are developed by the developing devices Gy, Gm, Gc, and Gk into toner images, which are examples of visible images.

The toner images obtained after the development are transported to the first transfer areas Q3y, Q3m, Q3c, and Q3k in which the toner images touch the intermediate transfer belt B, which is an example of an intermediate transfer body. In the first transfer areas Q3y, Q3m, Q3c, and Q3k, the power circuit E applies first transfer voltages, having a polarity opposite to the polarity with which toner is electrically charged, to the first transfer rollers T1y to T1k. Thus, the toner images on the photoconductors PRy to PRk are transferred to the intermediate transfer belt B by the first transfer rollers T1y to T1k. In the case of forming a multi-color toner image, a toner image disposed downstream is transferred so as to be superposed on a toner image that has been transferred to the intermediate transfer belt B in an upstream first transfer area.

Remnants or adherents remaining on the photoconductors PRy to PRk after the first transfer are removed by the photoconductor cleaners CLy to CLk. The cleaned surfaces of the photoconductors PRy to PRk are recharged by the charging rollers CRy to CRk.

A single-color or multi-color toner image that has been transferred to the intermediate transfer belt B by the first transfer rollers T1y to T1k in the first transfer areas Q3y to Q3k is transported to the second transfer area Q4.

Recording sheets S on which images are to be recorded are picked up by the pickup roller Rp on a selected one of the paper feed trays TR1 to TR3. When multiple recording sheets S are collectively picked up by the pickup roller Rp, the recording sheets S are separated one from another by the separation rollers Rs. Each recording sheet S separated by the separation rollers Rs is transported along the paper feed path SH1 by the transport rollers Ra. The recording sheet S that has been transported along the paper feed path SH1 is fed to the registration rollers Rr.

The registration rollers Rr transport the recording sheet S to the second transfer area Q4 at the same time when the toner image formed on the intermediate transfer belt B is transported to the second transfer area Q4. The power circuit E applies a second transfer voltage, having a polarity opposite to the polarity with which toner is electrically charged, to the second transfer roller T2b. Thus, the toner image on the intermediate transfer belt B is transferred from the intermediate transfer belt B to the recording sheet S.

Adherents or other matter adhering to the surface of the intermediate transfer belt B after the second transfer are removed by the belt cleaner CLb.

When the recording sheet S to which the toner image has been second transferred passes through the fixing area Q5, the toner image is heated and fixed to the recording sheet S.

The recording sheet S to which the image has been fixed is transported along the paper ejection path SH2. The recording sheet S that has been transported along the paper ejection path SH2 is ejected to the paper output tray TRh by the ejection rollers Rh.

### Description of Second Transfer Device

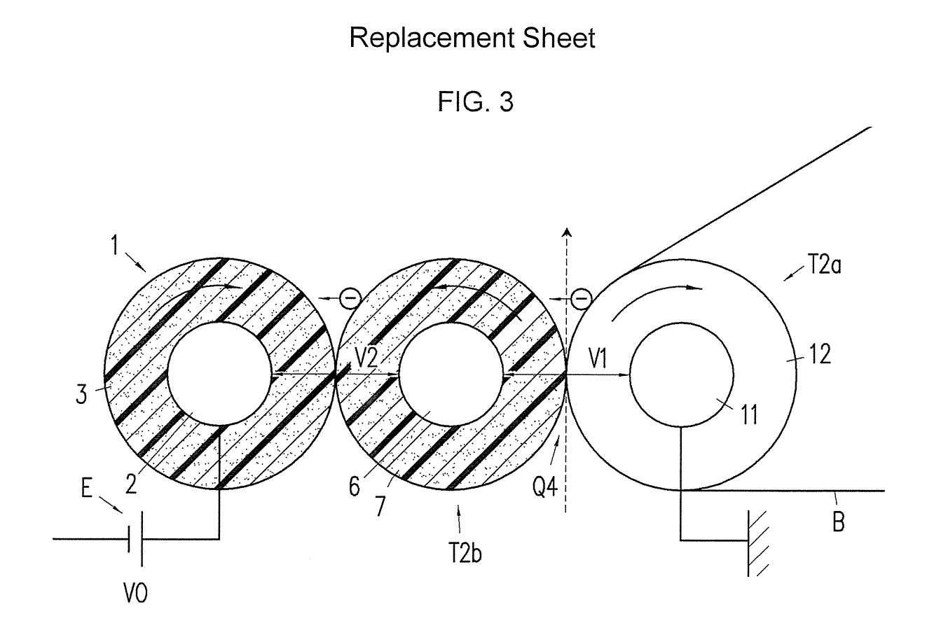

FIG. 3 illustrates a related portion of a transfer device according to an exemplary embodiment.

In FIG. 2 and FIG. 3, a cleaning roller 1, which is an example of a cleaning member, is in contact with the second transfer roller T2b according to the first exemplary embodiment at a portion opposite to a portion with which the back-up roller T2a is in contact. The cleaning roller 1 according to the first exemplary embodiment is cylindrical to be rotatable. Instead of autonomously driving, the cleaning roller 1 is supported to be driven to rotate with a rotation of the second transfer roller T2b.

The cleaning roller 1 includes a shaft 2. A voltage V0 is applied to the shaft 2. A roller body 3, which is an example of a body of a cleaning member, is supported on the outer surface of the shaft 2. The roller body 3 according to the first exemplary embodiment is formed of a polyurethane foam, which is an example of a foamed material. In the first exemplary embodiment, carbon black, which is an example of an electroconductive member, is added to the polyurethane foam to adjust an electrical resistance R2. Preferably, an electrical resistance R2 of the cleaning roller 1 is approximately 10⁷ to 10⁹ Ωm in volume resistivity.

As in the case of the cleaning roller 1, the second transfer roller T2b according to the first exemplary embodiment includes a shaft 6 and a roller body 7. The roller body 7 according to the first exemplary embodiment is formed from a polyurethane foam, which is an example of a foamed material. Specifically, in the first exemplary embodiment, the cleaning roller 1 and the second transfer roller T2b are made of the same base material. The second transfer roller T2b has its electrical resistance R1 adjusted by adding carbon black, an example of an electroconductive member, into the polyurethane foam. In the first exemplary embodiment, the electrical resistance R2 of the cleaning roller 1 is higher than the electrical resistance R1 of the second transfer roller T2b. Specifically, R1<R2. For example, in the first exemplary embodiment, the electrical resistances R1 and R2 satisfy 2×R1=R2.

The back-up roller T2a according to the first exemplary embodiment includes a shaft 11. The shaft 11 is grounded or earthed. The shaft 11 supports a roller body 12 on its outer periphery. The roller body 12 is made of, for example, ethylene propylene dien monomer (EPDM), which is an example of an elastic material. The roller body 12 has its electrical resistance R0 adjusted by adding carbon black, which is an example of an electroconductive member, into EPDM. Preferably, the electrical resistance R0 of the back-up roller T2a is lower than or equal to 10⁶ Ωm in volume resistivity.

The shafts 2, 6, and 11 are made of a metal material, and have negligibly a small electrical resistance compared to the resistances R0 to R2 of the roller bodies 3, 7, and 12. The electrical resistance R0 of the back-up roller T2a is smaller by one or more orders of magnitude than the electrical resistances R1 and R2 of the second transfer roller T2b and the cleaning roller 1. Thus, when compared to the second transfer roller T2b and the cleaning roller 1, the electrical resistance R0 of the back-up roller T2a is also negligibly small.

As described above, in the first exemplary embodiment, the back-up roller T2a is grounded. A voltage with the polarity opposite to that of the electric polarity with which toner is charged is applied to the cleaning roller 1 from a power circuit E, which is an example of a bias-voltage applicating device. Thus, a second transfer bias voltage is applied across the back-up roller T2a and the second transfer roller T2b via the cleaning roller 1. Thus, the cleaning roller 1 according to the first exemplary embodiment functions as a cleaning member for the second transfer roller T2b and as a power feeder.

### Effect of First Exemplary Embodiment

In the second transfer device T2 according to the first exemplary embodiment having the above structure, a bias voltage is applied to the cleaning roller 1 during second transfer. Thus, electric current flows through the cleaning roller 1, the second transfer roller T2b, and the back-up roller T2a, and voltages corresponding to the electrical resistances R0 to R2 are applied across the rollers T2a, T2b, and 1. Thus, an electric force is exerted between the second transfer roller T2b and the cleaning roller 1.

Here, a developer, paper dust, and other objects adhere to the second transfer roller T2b during second transfer. Particularly, in borderless printing, dirt on the second transfer roller T2b has a large effect. The dirt on the second transfer roller T2b stains the rear surface of the recording sheet S or causes a transfer defect. In the first exemplary embodiment, the second transfer roller T2b is capable of having its dirt recovered by the cleaning roller 1 to be cleaned with the electric force exerted between the second transfer roller T2b and the cleaning roller 1.

Particularly, in the first exemplary embodiment, R1<R2, so that the potential difference V2 between the second transfer roller T2b and the cleaning roller 1 is greater than the potential difference V1 between the back-up roller T2a and the second transfer roller T2b. For example, when V0=3000 V, provided that 2×R1=R2, V1=1000 V and V2=2000 V. Thus, the cleaning bias voltage V2 (=2000 V) is higher than the second transfer bias voltage V1 (=1000 V) in the second transfer area Q4. The electric force with which an adherent on the surface of the second transfer roller T2b is attracted to the cleaning roller 1 is greater than the electric force with which the adherent adheres to the surface. Thus, the dirt on the surface of the second transfer roller T2b is more easily electrically attracted to the cleaning roller 1, compared to the case of R1>R2. Thus, the second transfer roller T2b is kept from the dirt.

In the first exemplary embodiment, the cleaning roller 1 is capable of electrically attracting and holding dirt. This structure eliminates the need of a recovery container (cleaner container) for recovering the developer, and thus is allowed to be reduced in size as a whole. Particularly, the second transfer roller T2b is disposed near the side wall of the copying machine U, and the space for a recovery container is scarce. To dispose a recovery container in this space, the space may protrude sideways, or the width of the copying machine U needs to be increased. Elimination of a cleaner container contributes to size reduction of the entirety of the copying machine U.

Adherents accumulate over time on the cleaning roller 1 according to the first exemplary embodiment. Thus, after the completion of a job or printing of a predetermined number of sheets, preferably, a voltage of an opposite polarity is applied to the cleaning roller 1 to move dirt from the cleaning roller 1 to the intermediate transfer belt B via the second transfer roller T2b and to recover the dirt with a belt cleaner CLb. That is, preferably, the cleaning roller 1 performs a cleaning cycle or a cleaning sequence. Instead of the belt cleaner CLb, the dirt may be recovered by the photoconductor cleaners CLy to CLk.

In the first exemplary embodiment, the cleaning roller 1 has a rotatable roller shape. A fixed cleaning member, such as a cleaning blade, causes rotational resistance for the second transfer roller T2b when coming into contact with the second transfer roller T2b. Such a cleaning member increases torque required to rotate the second transfer roller T2b, so that the second transfer roller T2b driven by the rotation of the intermediate transfer belt B is more likely to slip off the intermediate transfer belt B. Thus, while a recording sheet S passes through the second transfer area Q4, the second transfer roller T2b may fail to be driven to rotate, so that the recording sheet S may be scratched or cause a paper jam. A driving source such as a motor used to drive the second transfer roller T2b to address this problem would increase the cost for driving. In the first exemplary embodiment, in contrast, the cleaning roller 1 has a rotatable roller shape and has a low rotational resistance. The cleaning roller 1 dispenses with a driving source, and prevents cost increase.

Particularly, a fixed cleaning member such as a cleaning blade is not suitable for the second transfer roller T2b formed of a foamed material. Specifically, a cleaning blade removes scarcely any adherents, and instead presses dirt into holes in the foamed portions. Thus, to use a cleaning blade, instead of the second transfer roller T2b made of a foamed material having an uneven surface, a roller having a smooth layer or film on the surface needs to be used as the second transfer roller T2b. A roller having a smooth surface is usually more expensive than a roller formed of a foamed material. In addition, failure to select a foamed material narrows the design freedom. In contrast, the structure according to the first exemplary embodiment electrically attracts dirt, and thus may remove dirt instead of a blade. The second transfer roller T2b may be made of a foamed material.

In addition, in the first exemplary embodiment, the cleaning roller 1 has a function of a power feeder for the second transfer roller T2b. The structure according to the first exemplary embodiment may thus reduce the number of components or the production cost, compared to the structure including separate power feeders.

### MODIFICATION EXAMPLES

Thus far, an exemplary embodiment of the invention has been described in detail. However, the invention is not limited to the above-described exemplary embodiment and may be modified in various manners within the gist of the invention described in the scope of claims. The following exemplarily describes modification examples (H01) to (H07) of the exemplary embodiment of the invention.

### H01

In the above-described exemplary embodiment, the copying machine U is described as an example of the image forming apparatus. However, the image forming apparatus is not limited to this example and may be a device such as a fax or a multifunctional machine having multiple functions such as the functions of a fax, a printer, and a copying machine. In addition, the image forming apparatus is not limited to an electrophotographic image forming apparatus and may be an image forming apparatus of another image forming type such as a photolithographic printer including an inkjet or thermal head printer. Moreover, the image forming apparatus is not limited to a multi-color developing image forming apparatus. The image forming apparatus may be a single-color or monochrome image forming apparatus. When the image forming apparatus is a monochrome image forming apparatus, an opposing member that faces a transfer member serves as an image carrier. Specifically, the image carrier may also serve as an opposing member.

### H02

In the exemplary embodiment, a cleaning member for the second transfer roller T2b is illustrated as an example of a transfer member, but this is not the only possible example. For example, the cleaning member is also usable as a cleaning member for any of the first transfer rollers T1y to T1k, and as a cleaning member for any of the charging rollers CRy to CRk.

### H03

In the exemplary embodiment, specific numerical values or materials exemplarily illustrated may be appropriately changed in accordance with the design or specifications.

### H04

In the exemplary embodiment, a foamed material is preferably used as the cleaning roller 1, but this is not the only possible example. A structure having an electrical resistance satisfying R1<R2 and having any form, such as a metal roller, a resin roller, a rotatable brush, or a roller having a surface made of cloth, is usable. Similarly, instead of a foamed material, the second transfer roller T2b may have an appropriate structure in accordance with the design or specifications.

### H05

In the exemplary embodiment, the cleaning roller 1 has a roller shape that is driven to rotate, but this is not the only possible shape. For example, the cleaning roller 1 may be a driving roller, or a fixed nonrotatable roller. Instead, the cleaning roller 1 may have a blade or block shape and electrically attract dirt in response to an application of a voltage.

### H06

In the exemplary embodiment, the amount of carbon black is adjusted to adjust the electrical resistances R0 to R2, but this is not the only way for resistance adjustment. For example, the thickness, hardness, or expansion rate of the roller bodies 3 and 7 may be changed to satisfy R1<R2. Besides, the intrusion amount, that is, the area over which the second transfer roller T2b and the cleaning roller 1 come into contact with each other, and the substantial diameter after elastic deformation may be adjusted to satisfy R1<R2.

### H07

In the exemplary embodiment, the cleaning roller 1 also serves as a power feeder. Alternatively, another power feeder may be disposed. Instead, the cleaning roller 1 may be grounded with an application of a bias voltage having a polarity opposite to that of the exemplary embodiment to the back-up roller T2a.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A transfer device comprising:
a rotatable transfer member that transfers an image held on an image carrier to a medium;
an opposing member opposing the transfer member and forming, between the opposing member and the transfer member, a transfer area for an image to be transferred;
a recovery member disposed in contact with the transfer member to electrically attract and recover an adherent adhering to the transfer member, wherein an electrical resistance of the opposing member is smaller by one or more orders of magnitude than electrical resistances of the transfer member and the recovery member; and
a bias-voltage applicating device that applies a transfer bias voltage to the transfer area via the recovery member, the transfer member, and the opposing member.

2. The transfer device according to claim 1,
wherein the electronical resistance of the recovery member is higher than the electrical resistance of the transfer member.

3. The transfer device according to claim 1,
wherein power is fed to the recovery member, and the opposing member is grounded.

4. The transfer device according to claim 2,
wherein power is fed to the recovery member, and the opposing member is grounded.

5. The transfer device according to claim 1,
wherein the recovery member rotates.

6. The transfer device according to claim 2,
wherein the recovery member rotates.

7. The transfer device according to claim 3,
wherein the recovery member rotates.

8. The transfer device according to claim 4,
wherein the recovery member rotates.

9. The transfer device according to claim 5,
wherein the recovery member is driven to rotate in accordance with rotation of the transfer member.

10. The transfer device according to claim 6,
wherein the recovery member is driven to rotate in accordance with rotation of the transfer member.

11. The transfer device according to claim 7,
wherein the recovery member is driven to rotate in accordance with rotation of the transfer member.

12. The transfer device according to claim 8,
wherein the recovery member is driven to rotate in accordance with rotation of the transfer member.

13. The transfer device according to claim 1,
wherein the recovery member is made of a foamed material.

14. The transfer device according to claim 13,
wherein the transfer member is made of a foamed material.

15. An image forming apparatus, comprising:
an image carrier;
the transfer device according to claim 1 that transfers an image on the image carrier to a medium; and
a fixing member that fixes the image transferred to the medium onto the medium.

16. A transfer device comprising:
rotatable transfer means for transferring an image held on an image carrier to a medium;
opposing means opposing the transfer means for forming, between the opposing means and the transfer means, a transfer area for an image to be transferred;
recovery means disposed in contact with the transfer means for electrically attracting and recovering an adherent adhering to the transfer means, wherein an electrical resistance of the opposing means is smaller by one or more orders of magnitude than electrical resistances of the transfer means and the recovery means; and
bias-voltage applicating means for applying a transfer bias voltage to the transfer area via the recovery means, the transfer means, and the opposing means.

17. The transfer device according to claim 1, wherein after adherents accumulate over time on the recovery member, the bias-voltage applicating device applies a voltage of an opposite polarity to the recovery member so as to move the accumulated adherents from the recovery member to the image carrier via the transfer member.
